(19) United States
(12) Patent Application Publication
(10) Pub. No.: US 2005/0223856 A1
(43) Pub. Date: Oct. 13, 2005

(54) Torque wrench with fastener indicator and system and method employing same

(76) Inventors: John Reynertson, Geneva, IL (US); Jerome M. Gauthier, Roselle, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/819,826

(22) Filed: Apr. 7, 2004

(51) Int. Cl. B25B 23/144

(52) U.S. Cl. 81/467

(57) ABSTRACT

A system for controlling torque related data is disclosed. The system may include one or more torque wrenches each having a first controller, and each being adapted to communicate with a second controller. Each torque wrench may further include a handle and a torquing tool. A torque sensor is disposed on each of the torque wrenches and is adapted to provide torque related data of a fastener to the first controller. The second controller is communicably coupled to the first controller and receives the torque data of the fastener.

### FIELD OF THE DISCLOSURE

The disclosure generally relates to hand tools and, more particularly, relates to torque wrenches.

### BACKGROUND OF THE DISCLOSURE

In many industrial applications, the tightening of threaded fasteners to a specific degree or torque is of extreme importance. For example, in the assembly of automobiles or aircraft, it is imperative that nuts, bolts, screws, lugs, and the like, are tightened to a pre-specified torque to ensure the resulting assembly functions properly not only at initial use, but over the long term. Moreover, it is not sufficient that the device simply be tightened as far as possible as this may result in stripping of the threads or vibrational problems in the resulting assembly.

Accordingly, it has long been known to use torque wrenches for tightening such devices. Such wrenches are not only able to rotate and tighten the device, but also provide the user with some sort of indication as to the torque being applied. Such devices can include a bendable beam type wrench having a straight strain gauge thereon, a ratchet type of assembly wherein each rotation or click of the ratchet represents a discrete level of torque being applied, and a shear stress type design wherein sensors are mounted to a transducer of the wrench.

Similarly, it is known in the art to store the torque values obtained from the torque wrenches manually. For example, operators on an assembly line, such as for aircraft or automobiles, or mechanics in a repair shop may torque fasteners to a certain torque value. Once fastened, the operator may either write the torque values on a piece of paper, such as a work order or quality control documents, or enter the torque values into a computer, or the like.

Unfortunately, controlling and storing the torque values in such as manner has many inherent problems such as causing inaccuracies and inefficiency in recording and controlling the torque values. For example, inaccuracies in the torque values may occur in many ways. The operator may misread the torque value displayed on the torque value indicator, forget to record the torque values altogether, remember the torque values incorrectly, and/or inadvertency write or enter the incorrect torque values onto the work order or into the computer. Such inaccuracies may lead to improperly tightened fasteners, which may in turn lead to expensive and disastrous results.

Similarly, the controlling of the torque values, when done manually, becomes cumbersome and inefficient. For example, the manual transferring of torque values as has been done in the art, is costly in time and introduces many steps, thereby making manual transferring of torque value difficult. More specifically, for an operator to manually record a torque values, the torque value may have to first be obtained by reading the torque value from the torque value indicator, the torque value may then have to be written onto a work order or quality control document, and then may have to be entered by the operator, or other third person, into a computer or have to be stored in a filing cabinet or other storage container.

### SUMMARY OF THE DISCLOSURE

In accordance with one aspect of the disclosure, a system for controlling torque related data is disclosed. The system may include at least one torque wrench having a torque sensor, a handle, a torquing tool, and a first controller. The torque sensor is disposed on the torque wrench and is adapted to provide torque related data of a fastener to the first controller. The system may further include a second controller that is communicably coupled to the first controller, and that receives the torque data of the fastener.

In accordance with another aspect of the disclosure, a torque wrench is disclosed. The torque wrench may include a handle, a torquing tool, at least one torque sensor, and a programmable interface module. The handle is operatively associated with the handle. The programmable interface module includes a fastener indicator and a first controller, wherein the torque sensor and the fastener indicator that are each communicably coupled to the controller, and wherein the fastener indicator indicates the number of fasteners that have been fastened.

In accordance with another aspect of the disclosure, a method of controlling torque related data is disclosed. The method includes obtaining actual torque related data from a torque sensor disposed on a torque wrench, and communicating the actual torque related data to a first controller, also disposed on the torque wrench. The method further includes activating a fastener indicator disposed on the torque wrench based on the actual torque related data.

### BRIEF DESCRIPTION OF THE DRAWINGS

FIG. 1 is a perspective view of one exemplary embodiment of a torque wrench constructed in accordance with the teaching of the disclosure;

FIG. 2 is a front view of the torque wrench of FIG. 1;

FIG. 3 is a top view of the torque wrench of FIG. 1;

FIG. 4 is a detailed front view of an interface module of FIG. 1;

FIG. 5 is an isometric view of the torque wrench of FIG. 1 and a holder adapted to receive the torque wrench;

FIG. 6 is an exemplary schematic block diagram of electronic components in the interface module of FIG. 4;

FIG. 7 is an exemplary schematic block diagram of the torque wrench of FIG. 1, communicably coupled to a network and other electronic devices;

FIG. 8 is an exemplary schematic block diagram of electronic components in an electronic device; and

FIG. 9 is a flowchart depicting one manner of operation of the torque wrench shown schematically in FIG. 6.

While the disclosure is susceptible to various modifications and alternative constructions, certain illustrative embodiments thereof have been shown in the drawings and will be described below in detail. It should be understood, however, that there is no intention to limit the disclosure to the specific forms disclosed, but on the contrary, the intention is to cover all modifications, alternative constructions, and equivalents falling within the spirit and scope of the invention as defined by the appended claims.

### DETAILED DESCRIPTION

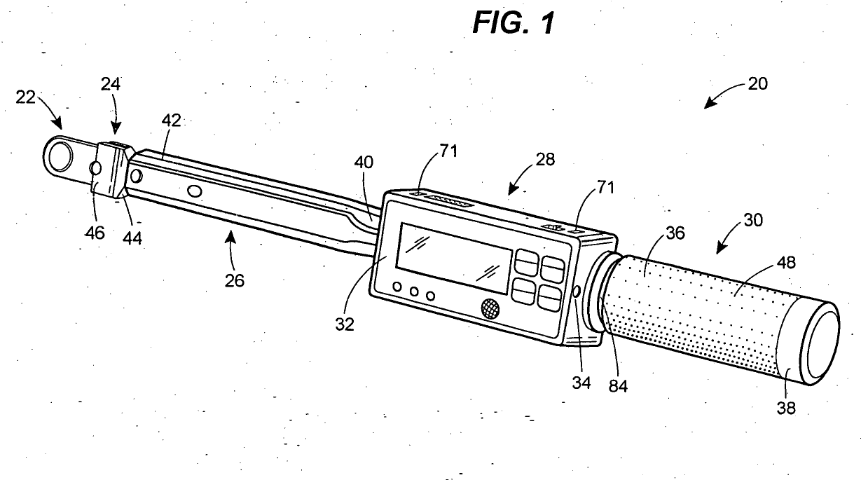

Turning now to the drawings, and with specific reference to FIG. 1, a torque wrench constructed in accordance with the teachings of the disclosure is generally referred to by reference numeral 20. As shown therein, the torque wrench 20 is of the type adapted to rotate a threaded fastener to a predetermined torque value. The torque wrench 20 may further be adapted to indicate the actual torque value, and may be adapted to indicate a torque range based on the actual torque value and the predetermined torque value. Such a high quality, accurate wrench is particularly applicable for use in tightly toleranced assembly processes including those of the automotive and aircraft industries. Moreover, while the torque wrench 20 is described and depicted as being a digital torque wrench, it is to be understood that its teachings could be employed for creating an analog output as well.

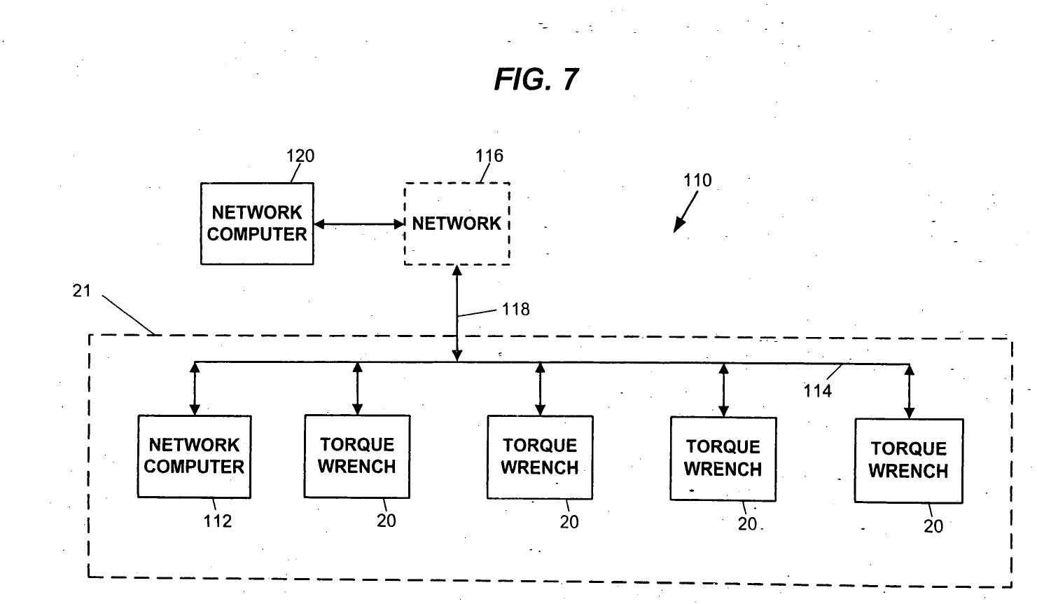

With reference to FIG. 7, a torque control system is depicted in accordance with the teachings of the disclosure and is generally referred to by reference numeral 21. As shown therein, the torque control system 21 includes at least one torque wrench 20 communicably coupled to another electronic device, such as a network computer 112, and is of the type adapted to control and store torque values obtained with the torque wrench 20. The torque control system 21 may further be adapted to control the tightening of fasteners on an object such as fasteners on a wheel of an automobile.

Referring now to FIGS. 1-3, the torque wrench 20 is shown to include a torquing tool 22, a transducer beam 24, a mounting bar 26, an interface module 28, and a handle 30. The interface module 28 has a first end 32 and a second end 34 wherein the second end 34 is disposed from a first end 36 of the handle 30. A second end 38 of the handle 30 provides an area for grasping of the wrench 20 by the operator. A second end 40 of the mounting bar 26 is disposed from the first end 32 of the interface module 28, with a first end 42 of the mounting bar 26 having disposed therefrom a first end 44 of the transducer beam 24. The torquing tool 22 is disposed from a second end 46 of the transducer beam 24 and may be adapted to engage any type of threaded fastener. To facilitate gripping the second end 38 of the handle 30 may be etched or provided with an elastomeric or other tactile covering 48.

The torquing tool 22, as illustrated in FIG. 3, includes a head 50 adapted to interfit with a conventional socket, but it is to be understood that the torquing tool 22 could be provided in a variety of other configurations including open-ended wrenches, box-head wrenches, flare nuts, tubing and other hand tool wrenching configurations. A tool mounting head 52 is disposed at the second end 46 of the mounting bar 26. The mounting tool head 52 includes a dove tail design having first and second rearward shoulders 54 adapted to interfit with, and grip to, the torquing tool 22.

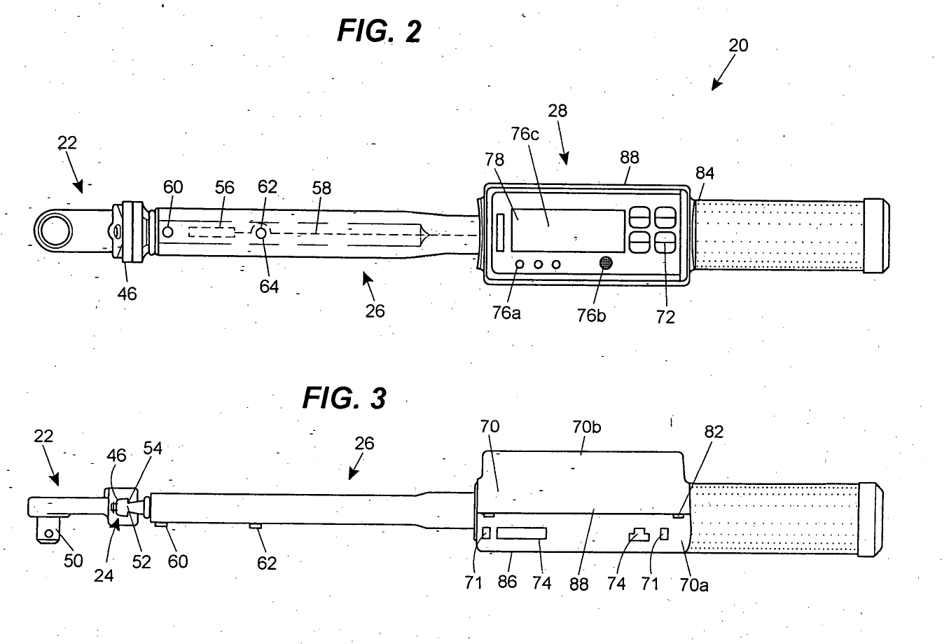

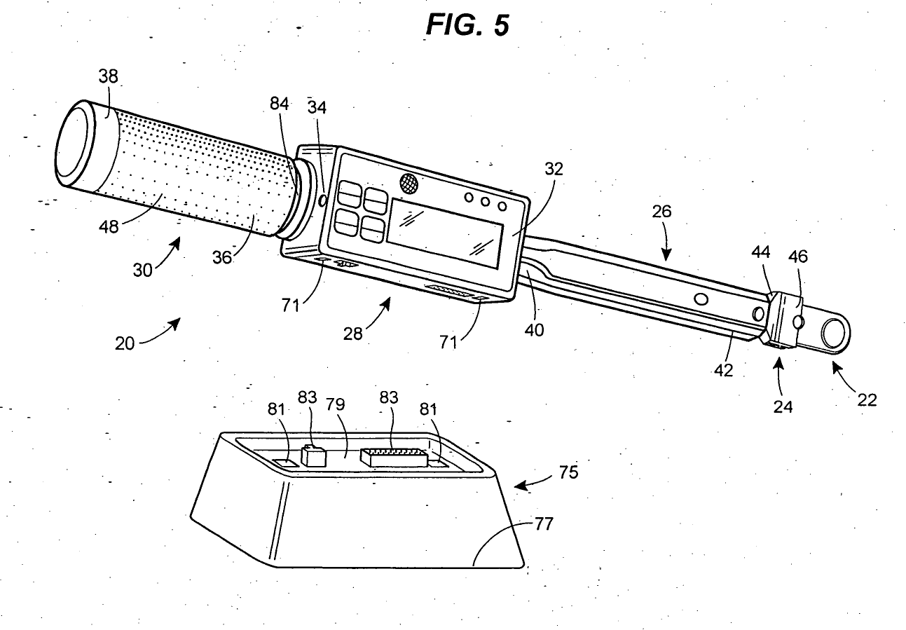

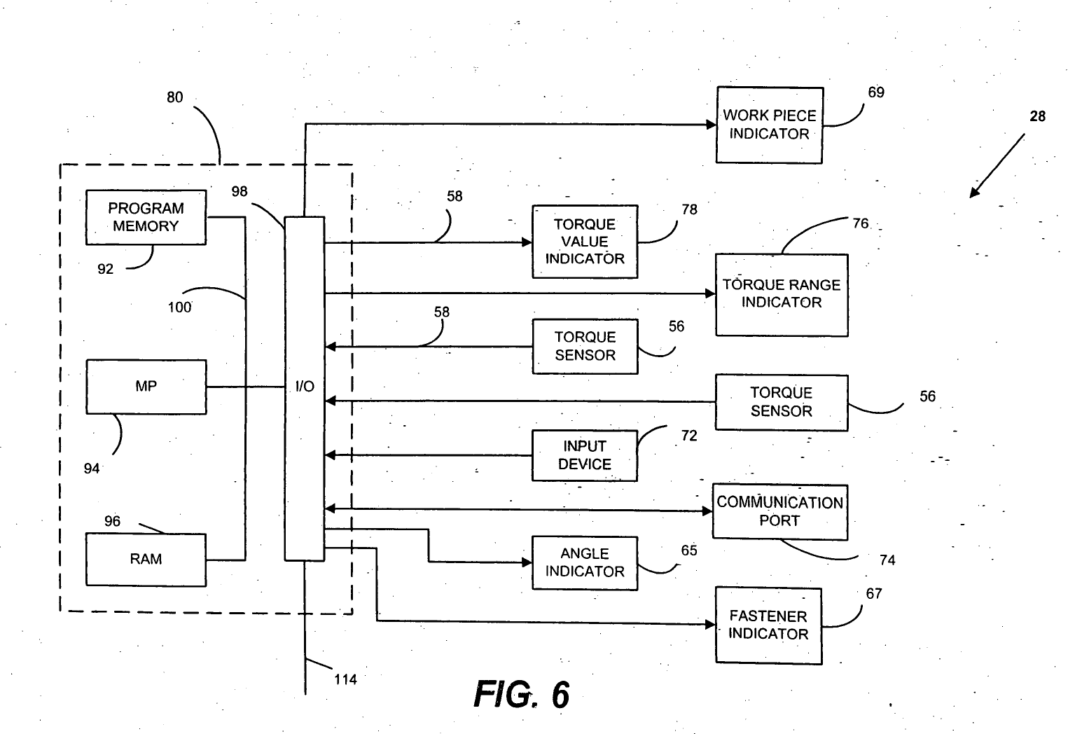

As will be described in further detail herein, the transducer beam 24 includes one or more sensors 56 (shown in phantom in FIG. 2 and shown schematically in FIG. 6) adapted to directly or indirectly measure a torque value on the fastener. The one or more sensors 56 may be arranged and mounted as described in U.S. Patent application Ser. No. 10/427/821, filed on May 1, 2003, assigned to the present assignee and incorporated herein by reference. As far as the construction of the one or more sensors 56 is concerned, bonded foil strain gauges of the type adapted to measure shearing stress are preferable. In order to communicably couple the one or more sensors 56 to the interface module 28, conductors 58 are provided (FIGS. 2 and 5).

Referring now to FIGS. 2-4, the manner in which the transducer beam 24 is connected to the mounting bar 26 is shown in detail. More specifically, it will be noted that first and second mounting pins 60, 62 are swaged to, or otherwise frictionally interfit with, the mounting bar 26 and the transducer beam 24 for securement thereof. The pins 60, 62 extend not only through mounting holes (not shown) provided within the transducer beam 24, but correspondingly aligned apertures 64 provided within the mounting bar 26. The mounting bar 26 may be secured to the handle 30 through the interface module 28, and more specifically, may be fixedly secured thereto as by welding or the like.

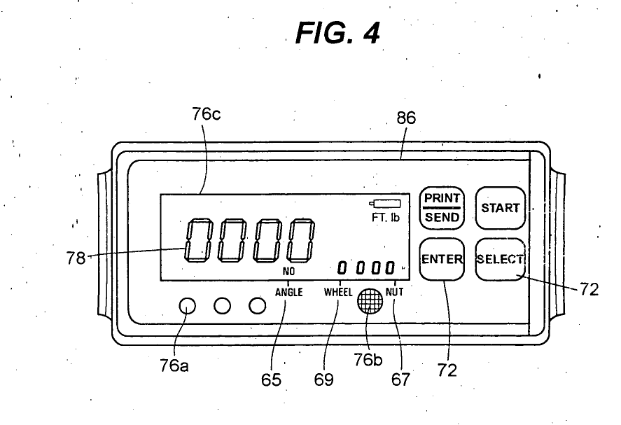

The programmable interface module 28 may include a housing 70, charge tabs 71, an input device 72 (FIGS. 2 and 4), a communications port 74 (FIGS. 3 and 6), a torque range indicator 76, a torque value indicator 78 (FIG. 4), and a controller 80 (FIG. 6). The housing 70, as seen in FIG. 3, is provided in first and second substantially clam-shell type halves 70a, 70b which can be secured around the handle 30 using rivets or other fasteners 82. However, the clam shell halves 70a, 70b provide a mounting aperture 84 sufficiently larger than the handle 30 to allow for a relatively easy rotation of the interface module 28 about the handle 30 (FIG. 2). As the interface module 28 is hard wired to the one or more sensors 56 by conductors 58, the degree of rotation of the interface module 28 on the handle 30 is governed by the length of the wiring 58. Accordingly, the pin and the slot (not shown) enables the interface module 28 to rotate, for example, thirty to sixty degrees, or whatever range of motion is afforded by the length of the wiring 58.

A front 86 of the housing 70 may include the input device 72, one or more of the torque range indicators 76a-c, and the torque value indicator 78. The input device 72, as seen in FIGS. 1 and 4, may be one or more buttons 72 adapted to receive input information from the user, or may be any other device adaptable to receive input from a user, including but not limited to, a touch screen, microphone, switch, or the like. The input device 72 may be configured to program the interface module 28, but may also be configured for activate/deactivate the interface module 28, change settings, enter values, print information, etc.

The one or more charge tabs 71 (FIG. 3) may be disposed anywhere on the torque wrench 20 and may, as in this exemplary embodiment, be disposed near the communications port 74. The charge tabs 71 may be constructed from a metal material, and may be electrically connected to a rechargeable battery of the torque wrench 20. As such, the battery of the torque wrench 20 may be recharged by electrically connecting the battery to the charge tabs 71. Alternatively, the charge tabs 71 may be one or more outlets adapted to receive a plug from a charging device (not shown).

The torque range indicator 76 and the torque value indicator 78, as seen in FIGS. 2 and 4, may be any type of indicator able to convey a torque range/value to the user, including any type of audio, visual and/or tactile indicator. For example, the torque range indicator 76 may be a light or bulb 76a that changes color as the torque ranges change, or may be a plurality of lights or bulbs 76a, wherein different bulbs are lit depending on the torque range. Similarly, the torque range indicator 76 may be a speaker 76b that provides a different sound depending on the torque range. The torque range indicator 76 may also be a backlit LCD screen 76c, wherein the backlighting changes color depending on the torque range. For example, the backlight of the LCD screen 76c may change from a yellow color indicating an unacceptably low torque range, to a green color indicating an acceptable torque range, to a red color indicating a too high torque range. The torque value indicator 78 may similarly vary, but in this exemplary embodiment, as seen in FIG. 4, is digital numerical indicator 78. The torque value indicator 78 and its operation of use may be arranged and utilized as described in U.S. patent application Ser. No. 10/427,821, which was filed on May 1, 2003, and is incorporated herein by reference

The programmable interface module 28, as best seen in FIG. 4 and schematically in FIG. 6, may further include an angle of rotation indicator 65, a fastener indicator 67, and a work piece indicator 69 and may, in other contemplated embodiments, include additional work piece indicators 69 (not shown). The angle of rotation indicator 65 may be any type of indicator able to indicate whether a fastener has undergone a proper angle of rotation. The angle of rotation indicator 65 may be an audio, visual, or tactile type of indicator and may, as in this embodiment, be an alphabetical indicator such that the angle of rotation indicator 65 may indicate a “Yes” or “Y” and “No” or “N” depending on whether or not a proper angle of rotation was achieved.

The fastener indicator 67 may, as in this embodiment, be a numerical indicator relating to the number of fasteners that have been properly tightened. For example, after an operator has tightened a nut on a wheel of an automobile to an acceptable torque value, the indicator may be a visual indication of how many of the fasteners have been properly tightened. Similarly, the work piece indicator 69 may also be a numerical indicator relating to the number of work pieces that have been properly completed. For example, if the work piece, such as the wheel in this exemplary embodiment, has been properly tightened with all of the fasteners necessary or required to complete the wheel, the work piece indicator may be a visual indication of how many of the wheels have been properly completed. Additional work piece indicators 69 (not shown) may be utilized to provide an indication of other work pieces that have been properly completed. For example, the work piece may be the entire automobile, such that the programmable interface module 28 may provide an indication of not only how many fasteners and wheels have been completed, but also of how many automobiles have been properly completed.

A top 88 of the housing 70, as seen in FIG. 3, may include the one or more communications ports 74 adapted to communicatively couple the torque wrench 20 to an electronic device or network. The communications port 74 may an RJ-45 jack, telephone port, a parallel port, a USB Port, a serial port, an OEM communications port or may be a wireless communications port, such that the communication port 74 may not be visually apparent, but is located inside the interface module 28. As such, the input device 72 may be communicably coupled to the torque wrench 20 via the communications port 74.

Additionally, the torque wrench 20 may be coupled via the communications port 74 while being disposed in a holder 75, as seen in FIG. 5, such as a docking station or cradle. The holder 75 may include a base 77, a receiving portion 79, charge pins 81, and port adaptors 83. The base 77 may include a mechanism, aperture, or attachment for attaching the holder 75 to a wall or other object, or may be substantially flat for placement of the holder on a generally flat surface, such as a table, tool box, etc. The receiving portion 79 may be a recess or cavity as shown in FIG. 5, adapted to receive at least some portion of the torque wrench 20, but may be any type of receiving portion 79 adaptable to receive the torque wrench 20. The charge pins 81 and port adaptors 83 may be disposed anywhere on the holder 79 engageable with the communications port 74 and may, as in this example, be disposed within the receiving portion 79. As such, when the torque wrench 20 is disposed in the receiving portion 79, the charge pins 81 and port adaptors 83 may be aligned with the charge tabs 71 and the communications part 74, thereby enabling the torque wrench 20 to be charged and/or communicably coupled by placement of the torque wrench 20 into the holder 75.

In schematic form, as shown in the block diagram of FIG. 6, a number of components may be incorporated in the interface module 28. Referring to FIG. 6, the interface module 28 may include a controller 80 that may comprise a program memory 92, a microcontroller or microprocessor (MP) 94, a random-access memory (RAM) 96, and an input/output (I/O) circuit 98, all of which may be interconnected via an address/data bus 100. It should be appreciated that although only one microprocessor 94 is shown, the controller 80 may include additional microprocessors. Similarly, the memory of the controller 80 may include multiple RAMs 96 and multiple program memories 92. Although the I/O circuit 98 is shown as a single block, it should be appreciated that the I/O circuit 98 may include a number of different types of I/O circuits.

FIG. 6 illustrates that the one or more torque sensor 56, the torque value indicator 78, the torque range indicator 76, the communications port 74, and an input device 72 may be operatively coupled to the I/O circuit 98, each of those components being so coupled by either a unidirectional or bidirectional, single-line or multiple-line data link, which may depend on the design of the component that is used.

As shown in FIG. 6, the components 56, 65, 67, 69, 72, 74, 76, and 78 may be connected to the I/O circuit 98 via a respective direct line or conductor. Different connection schemes could be used. For example, one or more of the components shown in FIG. 6 may be connected to the I/O circuit 98 via a common bus or other data link that is shared by a number of components. Furthermore, some of the components may be directly connected to the microprocessor 94 without passing through the I/O circuit 98.

As illustrated in the block diagram of FIGS. 6 and 7, the torque wrench 20 may be coupled to a group or network 110 of torque wrenches 20. The network 110 may be operatively coupled to a network computer 112 via a network data link or bus 114. The network 110 may be operatively coupled to other networks 116, which may comprise, for example, the Internet, a wide area network (WAN), or a local area network (LAN), via a network link 118.

The network 116 may include one or more network computers 120 or server computers, each of which may be operatively interconnected. Where the network 116 comprises the Internet, data communication may take place over the communication link 118 via an Internet communication protocol. In other examples, the network 116 may be, but is not limited to, a private and/or proprietary network, or a traditional network. Similarly, other types of protocols may be used to communicate over the communication link 118, including, but not limited to, proprietary serial based networking protocols.

The network computer 112 may be a server computer and may be used to accumulate and analyze data relating to the operation of the torque wrench 20. For example, the network computer 112 may be personal computer located in a reception area or an office portion of an auto-maintenance or auto-repair facility that is communicably coupled to one or more torque wrenches 20 via a wireless network 114. As such, the personal computer 112 may receive actual torque related data from each of the torque wrenches 20, continuously, intermittently, and/or as the operator desires. For example, the operator after having completed a job, (i.e. tightened all the necessary fasteners) may download all the torque related data such torque values, torque ranges, etc. to the personal computer 112.

The network computer 120 may be a server computer and may be used to perform the same and/or different functions in relation to the torque wrenches 20 as the network computer 112 described above. For example, the network computer 120 may be a server or computer located at an off-site storage facility for storing the torque related data, or may be a server or computer located at a different auto-repair facility or at an auto-repair headquarters for analyzing and/or storing the torque related data. The network computer 120 may also be a server or computer located at other third party facilities, such as at an auto-parts provider or at an auto manufacturer. The network computer 120 regardless of where it is located, or by whom it is operated, may also be adapted to provide pre-determined torque related data. More specifically, the network computers 120 and/or 112 may provide a variety of information related to the fasteners and/or the work pieces with which the fasteners are used. For example, in this exemplary embodiment the information related to the fasteners may include optimal torque values and/or torque ranges to which the fasteners should be tightened. The information related to the work piece may include the type of vehicle, the number of wheels on the vehicle, and the number of fasteners on each of the wheels.

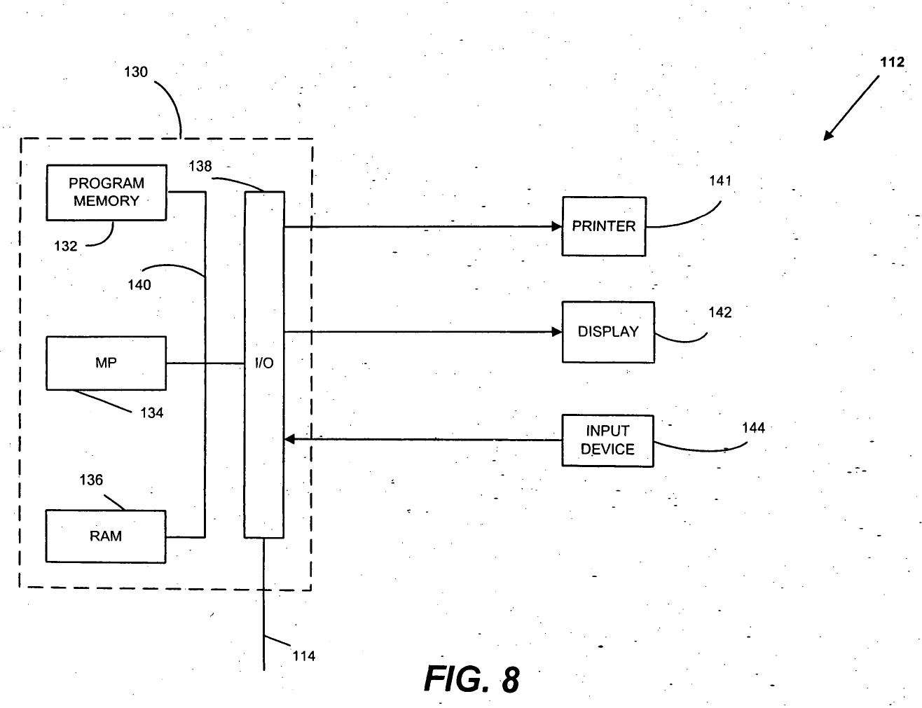

In schematic form, as shown in the block diagram of FIG. 8, a number of components may be incorporated in the electronic devices capable of being communicably coupled to the interface module 28. In this exemplary embodiment, the network computer 112 may include a controller 130 that may comprise a program memory 132, a microcontroller or microprocessor (MP) 134, a random-access memory (RAM) 136, and an input/output (I/O) circuit 138, all of which may be interconnected via an address/data bus 140. It should be appreciated that although only one microprocessor 134 is shown, the controller 130 may include additional microprocessors. Similarly, the memory of the controller 130 may include multiple RAMs 136 and multiple program memories 132. Although the I/O circuit 138 is shown as a single block, it should be appreciated that the I/O circuit 138 may include a number of different types of I/O circuits.

FIG. 8 illustrates that a printer 141, a display 142, and an input device 144 may be operatively coupled to the I/O circuit 138, each of those components being so coupled by either a unidirectional or bidirectional, single-line or multiple-line data link, which may depend on the design of the component that is used.

As shown in FIG. 8, the components 141, 142, and 144 may be connected to the I/O circuit 138 via a respective direct line or conductor. Different connection schemes could be used. For example, one or more of the components shown in FIG. 8 may be connected to the I/O circuit 138 via a common bus or other data link that is shared by a number of components. Furthermore, some of the components may be directly connected to the microprocessor 134 without passing through the I/O circuit 138.

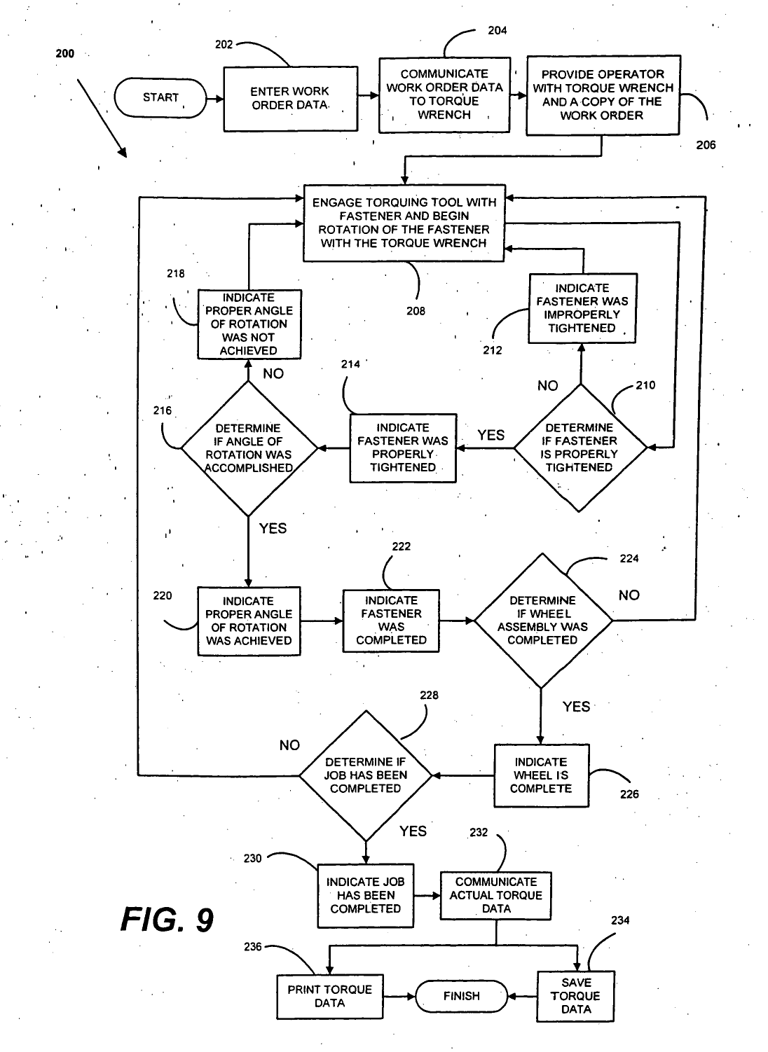

In one exemplary embodiment of an operation (200), as diagrammed in FIG. 9, it can be seen by one of ordinary skill in the art that the torque control system 21 can be employed for rotating threaded fasteners to a specified torque and controlling and storing those values once properly tightened. For sake of clarity and brevity, the operation 200 of the torque control system 21 will herein be described in terms of one torque wrench being used to tighten twenty fasteners or four different wheels of an automobile, but may obviously be adapted to tighten any number of fasteners, on any number or type of objects, using any number of torque wrenches. The torque control system 21 may also be used in additional and varying manners. For example, the torque control system 21 may be used in any situation where it may be desirable to control torque values, such as on assembly lines, construction projects, repair and/or maintenance of motorcycles, aircraft, appliances, etc.

At a block 202 of the operation 200, the user may communicate work order data to the torque wrench. The user may communicate the work order data to the torque wrench 20 from an electronic device such as the network computer 112 having the controller 130, or any other personal computer, network station, or personal storage device. The work order data may be communicated from the electronic device to the torque wrench 20 via any number of ways, including but not limited to, the internet, a network, a LAN, a WAN, wireless, etc. This step, however, may include additional steps prior to being executed. More specifically, before communicating the work order data to the torque wrench 20, the work order data may first need to be obtained.

The work order data may include, but is not limited to, an identifier, predetermined torque values, torque value ranges, and object data. The identifier may be indicative of the work order, such as a number or barcode, or may be indicative of a customer, a specific object, etc. The predetermined torque values may be acceptable and/or optimal torque values to which the fasteners can be tightened. Similarly, the torque value ranges may be indicative of the actual torque value of the fasteners prior to, at, and/or past the acceptable and/or optimal torque value range. The object data may include information regarding the fasteners and/or the object to which the fasteners are to be fastened.

In this exemplary embodiment, the identifier may be a work order number that is generated for the specific purpose of identifying the work order. The predetermined torque values may be values obtained from a manual, or the like, indicating that the torque value of the fasteners should be approximately 100 lbs/ft². The torque value ranges, may include but are not limited to, too low, too high, and acceptable. This determination may be accomplished in several ways, including but not limited to, determining whether the actual value is within a percentage of the predetermined value. For example, if the optimum torque value to be achieved is 100±5 lbs/ft², then the various ranges may be calculated by a percentage of the optimum value, such as 75% and 125%. As such, the acceptable torque range may be between 95 and 105 lbs/ft², the too low torque range may be between 75 and 95 lbs/ft², and the too high torque range may be between 105 and 125 lbs/ft². The object data, in this exemplary embodiment, may include the model, year, and make of the automobile, the number of wheels of the automobile, the number of fasteners of each of the wheels, and/or the type of fastener of the wheels.

The work order data may be entered into the network computer 112, via the input device 144, such as a keyboard or a mouse. Additionally and/or alternatively, one or more pieces of information from the work order may already be stored in the network computer 112, such that the user may retrieve the information from the program memory 132. Once the work order data has been entered, it may be communicated to the torque wrench 20 at the block 204. Control may then pass to block 206.

At the block 206, an operator may be provided with a copy of the work order and the torque wrench 20. As such, the operator is now in possession of the torque wrench 20 including the work order data and perhaps a copy of the work order, such that the operator may be able to identify an automobile corresponding to the work order 20. The torque wrench 20 at this juncture may display a torque value of zero and a wheel and nut value of zero as well. Once the operator has been provided with a copy of the work order and the torque wrench 20, control may pass to block 208. At the block 208, the operator may place the torque wrench 20 on a fastener and begin tightening or torquing the fastener of the wheel of the automobile. Control may then pass to block 210.

At the decision diamond 210, it will determine whether the fastener of the block 208 has been properly tightened. This determination may be made in several ways. In one exemplary embodiment, the operator may turn the torque wrench 20 and hence the fastener until the torque value indicator reads between 95 and 105 lbs/ft² or, more specifically, reads 100 lbs/ft². In another exemplary embodiment, the operator may use the torque range indicator 76 to determine whether the fastener has been properly tightened. For example, if it is determined that the torque value is too low (i.e. the actual torque value is below 95 lbs/ft²) then the torque value indicator 76c may be yellow, thereby indicating that the torque value is too low. If it is determined that the torque value is acceptable (i.e. the actual torque value is between 95 and 105 lbs/ft²) then the torque value indicator 76c may be green, thereby indicating that the torque value is acceptable. If it is determined that the torque value is too high (i.e. the actual torque value is above 105 lbs/ft²) then the torque value indicator 76c may be red, thereby indicating that the torque value is too high.

Regardless of the manner in which it is determined whether the fastener at the block 208 has been properly tightened, if the torque value of the fastener is too low, control may pass to block 212 to indicate that the torque value of the fastener is too low. Control may then pass to block 208, so the operator may continue to tighten the fastener. If, at the decision diamond 210, it determined that the torque value of the fastener is too high, control may pass to block 212 to indicate that the torque value of the fastener is too high, so that the operator may loosen the fastener, thereby passing control to the block 208 and requiring the operator to re-tighten the fastener. If it is determined that the torque value of the fastener is acceptable, control may pass to block 214 to indicate that the torque value of the fastener is acceptable.

At decision diamond 216, it may be determined if the fastener underwent an angle of rotation at the block 208. More specifically, at the block 208 the operator may have engaged a fastener that was previously fastened, unbeknownst to the operator or otherwise. Under such circumstances, the torque range indicator 76 and/or the torque value indicator 78 may indicate an acceptable torque range and/or value, once the operator has rotated the torque wrench 20 on the fastener sufficiently to obtain the acceptable torque range and/or value. This acceptable torque range and/or value would be misleading, however, in that the fastener was not actually fastened to an acceptable range and/or value, but was rather fastened to an acceptable range and/or value previously. The relevance of this will later become apparent.

Therefore, to account for the possibility that the determined acceptable torque range and/or value at the decision diamond 210, was related to a fastener that was presently fastened, and not to a fastener that has been tightened previously, it may be determined, at the decision diamond 216, if the fastener underwent an acceptable angle of rotation at the block 208. For example, if the fastener underwent an angle of rotation greater than ninety degrees, at the block 208, then it may be determined that the fastener had not been previously tightened, and the acceptable torque range and/or value would then correspond to a currently tightened fastener. If, however, the fastener underwent an angle of rotation less than ninety degrees, at the block 208, then it may be determined that the fastener was previously tightened.

If it is determined that the angle of rotation is acceptable, control may pass to block 220 to indicate a “Y” on the angle indicator 65. If, however, it is determined that the angle of rotation of the fastener is not acceptable, control may pass to block 218 to indicate an “N” on the angle indicator 65. Control may then pass to the block 208 for the operator to loosen and retighten the fastener.

Once control has passed to the block 220 the torque wrench 20 may indicate that the fastener has been properly tighten via the fastener indicator 67 at block 222. As such, the fastener indicator 67, as in this exemplary embodiment, may indicate the number “1”, thereby verifying that one fastener has been properly tighten. Control may then pass to decision diamond 224.

At the decision diamond 224, it may be determined whether all the fasteners on the work piece, in this exemplary embodiment the wheel, have been properly tightened. Knowing that the wheel requires five fasteners, for example, it will be determined that only one of the five fasteners have been properly tightened and that four remain to be tightened. As such, control may pass to the block 208, such that the operator may fasten another fastener. This cycle will reoccur until all five of the fasteners have been properly tightened. Once, for exemplary purposes only, all five of the fasteners of the wheel have been properly tightened, it will be determined that the wheel has been completed, and control may pass to block 226. Prior to control passing to the block 226 the fastener indicator 67 may, at this juncture, indicate the number “5”, thereby verifying that five fasteners have been properly tightened.

Once control has passed to the block 226 the torque wrench 20 may indicate that the wheel has been completed via the work piece indicator 69. As such, the work piece indicator 69, as in this exemplary embodiment, may indicate the number “1”, thereby verifying that one object has been properly tighten and is complete. Simultaneously, the fastener indicator 67 may reset and return to “0”. The return to zero on the fastener indicator 67 would indicate that none of the fasteners on the next work piece (i.e. the next wheel) have been properly tightened. Once it is indicated that the wheel has been completed, control may pass to a decision diamond 228.

At the decision diamond 228, it may be determined whether the job has been completed or, as in this exemplary embodiment, whether all of the fasteners on all of the wheels have been properly tightened. Continuing with the scenario that only one wheel has been properly completed (i.e. the fastener indicator 67 reads “0” and the work piece indicator 69 reads “1”), it will be determined that the job has not been completed, because only one wheel has been properly tightened and three wheels remain to be tightened. As such, control may pass to the block 208 such that the operator may continue tightening the next fastener on the next work piece. This cycle will reoccur until all four of the wheels have been properly tightened. Once, for exemplary purposes only, all four of the wheels have been properly completed, it will be determined, at the decision diamond 228, that the job has been completed. Once the job has been completed, control may pass to block 230.

At the block 230, the torque wrench 20 may indicate that the job has been completed. The completion of the job may be indicated in several ways, including but not limited to, resetting and the work piece indicator 69 and/or the fastener indicator 67 to zero, flashing or otherwise activating one or more of the work piece indicator 69, the torque value indicator 78, the torque range indicator 76, and/or the fastener indicator 67, or a combination thereof. Once it is indicated that the job has been completed, control may pass to block 232.

At the block 232, the torque data obtained by completing the job may be communicated from the torque wrench 20 to the network computer 112. The torque data may include, but is not limited to, torque values, torque range data, the identifier, wheel data, fastener data, etc.

Once the torque data is communicated to the electronic device (i.e. the network computer 112), the torque data may be utilized and/or manipulated in any number of ways. For example, at block 234 the torque data may be stored the memory 132 or into a database, or further may be communicated to other electronic devices where it may be stored or utilized. At the block 236, the torque data may be printed on the work order, a receipt, or the like, such that the customer may have proof that the fasteners and hence the wheels were properly tightened and completed.

This exemplary operation 200, may include additional and alternate steps, and may occur in different orders or have steps removed. For example, the operation 200 may include additional instances during which the torque data is saved and/or communicated to the network computer 112. Similarly, the torque data may also be saved in additional locations, such as in the torque wrench 20 or additional electronic devices.

While the present invention has been described with reference to specific examples, which are intended to be illustrative only and not to be limiting of the invention, it will be apparent to those of ordinary skill in the art that changes, additions, or deletions may be made to the disclosed embodiments without departing from the spirit and scope of the invention.

1. A system for controlling torque related data, comprising:
a torque wrench having a handle, a torquing tool, a torque sensor, and a first controller, the torque sensor being adapted to provide torque related data of a fastener to the first controller; and
a second controller communicably coupled to the first controller, wherein the second controller receives the torque data of the fastener.

2. The system for controlling torque related data of claim 1, wherein the second controller is disposed in a network computer communicably coupled to the torque wrench.

3. The system for controlling torque related data of claim 1, wherein the torque related data is an actual torque value.

4. The system for controlling torque related data of claim 1, wherein the torque related data is an actual torque range.

5. The system for controlling torque related data of claim 1, wherein the torque related data is a pre-determined torque value.

6. The system for controlling torque related data of claim 1, wherein the torque related data is a pre-determined torque range.

7. The system for controlling torque related data of claim 1, wherein the torque wrench further includes a torque value indicator.

8. The system for controlling torque related data of claim 1, wherein the torque wrench further includes a torque range indicator.

9. The system for controlling torque related data of claim 1, wherein the torque wrench further includes a fastener indicator.

10. The system for controlling torque related data of claim 1, wherein the torque wrench further includes a work piece indicator.

11. The system for controlling torque related data of claim 1, wherein the torque wrench further includes an angle of rotation indicator.

12. The system for controlling torque related data of claim 1, further including a plurality of torque wrenches each coupled to the second controller via a network.

13. The system for controlling torque related data of claim 1, wherein the first controller is communicably coupled to the second controller via a wireless network.

14. The system for controlling torque related data of claim 1, wherein the first controller is communicably coupled to the second controller via a LAN network.

15. The system for controlling torque related data of claim 1, wherein the first controller is communicably coupled to the second controller via the internet.

16. The system for controlling torque related data of claim 1, further including a docking station adapted to receive the torque wrench.

17. The system for controlling torque related data of claim 16, wherein the docking station includes an electrical connector and the torque wrench includes an electrical connector for electrically charging the torque wrench.

18. The system for controlling torque related data of claim 16, wherein the docking station is communicably coupled to at least one of the first and second controllers.

19. A torque wrench, comprising:
a handle;
a torquing tool operatively associated with the handle;
at least one torque sensor; and
a programmable interface module having a first controller and a fastener indicator, the fastener indicator being adapted to indicate the number of fasteners that have been fastened, the torque sensor and the fastener indicator being communicably coupled to the controller.

20. The torque wrench of claim 19, further including a communications port for communicably coupling the first controller to a second controller.

21. The torque wrench of claim 19, further including a torque value indicator communicably coupled to the first controller.

22. The torque wrench of claim 19, further including a torque range indicator communicably coupled to the first controller.

23. The torque wrench of claim 19, further including a work piece indicator communicably coupled to the first controller.

24. The torque wrench of claim 19, further including an angle of rotation indicator communicably coupled to the first controller.

25. A torque wrench, comprising:
a handle;
a torquing tool operatively associated with the handle;
at least one torque sensor; and
a programmable interface module having a first controller and a work piece indicator, the work piece indicator being adapted to indicate the number of work pieces that have been fastened, the torque sensor and the work piece indicator being communicably coupled to the controller.

26. The torque wrench of claim 25, further including a communications port for communicably coupling the first controller to a second controller.

27. The torque wrench of claim 25, further including a torque value indicator communicably coupled to the first controller.

28. The torque wrench of claim 25, further including a torque range indicator communicably coupled to the first controller.

29. The torque wrench of claim 25, further including a fastener indicator communicably coupled to the first controller.

30. The torque wrench of claim 25, further including an angle of rotation indicator communicably coupled to the first controller.

31. A method of controlling torque related data, comprising:
obtaining actual torque related data from a torque sensor disposed on a torque wrench;
communicating the actual torque related data to a first controller disposed on the torque wrench; and
activating at least one of a fastener indicator and a work piece indicator disposed on the torque wrench based on the actual torque related data.

32. The method of controlling torque related data of claim 31, further including activating a torque value indicator.

33. The method of controlling torque related data of claim 31, further including activating a torque range indicator.

34. The method of controlling torque related data of claim 31, further including activating an angle of rotation indicator.

35. The method of controlling torque related data of claim 31, further including entering pre-determined torque related data into the first controller.

36. The method of controlling torque related data of claim 35, wherein the pre-determined torque related data is entered into the first controller by communicating the pre-determined torque related data from a second controller.

37. The method of controlling torque related data of claim 31, further including placing the torque wrench into a docking station.

38. The method of controlling torque related data of claim 31, further including communicating the actual torque related data from the first controller to a second controller.

39. The method of controlling torque related data of claim 38, further including using at least one of a wireless network, WAN, and LAN to communicate the actual torque related data from the first controller to the second controller.

40. The method of controlling torque related data of claim 31, wherein obtaining the actual torque related data from a torque sensor further includes rotating a fastener.
